(19) United States
(12) Patent Application Publication
(10) Pub. No.: US 2026/0220419 A1
(43) Pub. Date: Jul. 30, 2026

(54) SYSTEM AND METHOD TO LEVERAGE AGENTIC FOUNDATIONAL MODELS TO ENHANCE GRAPH NEURAL NETWORKS IN MOBILE COMMUNICATION

(71) Applicant: Dell Products L.P., Round Rock, TX (US)

(72) Inventors: Gwenael Poitau, Montreal (CA); Ibrahim Abu Alhaol, Nepean (CA); Javad Mirzaei, Toronto (CA); Rohit Arora, San Jose, CA (US); Said Tabet, Austin, TX (US)

(21) Appl. No.: 19/039,284

(22) Filed: Jan. 28, 2025

(51) Int. Cl. G06N 3/042; G06N 3/08

(52) U.S. Cl. CPC G06N 3/042; G06N 3/08

(57) ABSTRACT

Enhanced network graphs and graph neural networks (GNNs) are disclosed. In a system that includes a radio access network and a radio intelligent controller (RIC), the RIC is configured to receive multi-modal data along with other data. Semantic features from the multi-modal data are combined with features from the other data. The combined features are used to enhance a network graph of the network and to train a GNN whose feature embeddings are enhanced with the multi-modal data. Decisions made in the network may be based on the feature embeddings, which account for multi-modal data and network inter-dependencies.

### TECHNOLOGICAL FIELD OF THE DISCLOSURE

Embodiments disclosed herein generally relate to model-based network optimization. More particularly, at least some embodiments relate to systems, hardware, software, computer-readable media, and methods for optimizing network operations and functions using-models to enhance network graphs and/or graph neural networks (GNNs).

### BACKGROUND

Machine learning technologies have been successfully used in a variety of domains including vision and natural language processing. Attempts have been made to integrate machine learning technologies into heterogeneous network (e.g., radio area network (RAN)) systems and applications. One of the reasons is that RANs are associated with large amounts of data and include a variety of network technologies and topologies, many of which have not been seen by machine learning. Machine learning technologies, their traditional form, do not scale well in heterogeneous networks and are unable to suitably generalize for the various network topologies.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1A discloses aspects of a network such as a radio access network (RAN) or an open radio access network (O-RAN);

FIG. 1B discloses aspects of a network graph of a network enhanced with multi-modal data;

FIG. 2 discloses aspects of a system that includes a network that is configured to enhance network graphs and/or GNNs that may be employed in or by a radio intelligent controller (RIC) with multi-modal data;

FIG. 3 discloses additional aspects of an RIC that may include or have access to a network graph and/or a GNN enhanced with multi-modal data;

FIGS. 4-5 illustrate additional aspects of systems for using AFMs to enhance network graphs and/or GNNs;

FIG. 6 discloses aspects of enhancing RICs and more specifically to enhancing network graphs and/or GNNs in network RICs; and

FIG. 7 discloses aspects of a computing device, a computing system, or a computing entity.

### DETAILED DESCRIPTION OF SOME EXAMPLE EMBODIMENTS

Embodiments disclosed herein generally relate to network graphs of networks included in or accessible by radio intelligent controllers (RICs). More particularly, at least some embodiments relate to systems, hardware, software, computer-readable media, and methods for model-based enhancement of network graphs of networks and to performing network control and management operations based on data stored in an enhanced network graph.

Embodiments of the invention are discussed in the context of a network such as an open radio access network (O-RAN). Embodiments of the invention may be implemented in other networks including RANs, telecommunication (cellular) networks, wireless/wired networks and the like or combinations thereof.

Embodiments of the invention generally relate to enhancing a network graph based on multi-modal data received from a network. Embodiments of the invention collect or receive multi-modal data from a network. Multi-modal data includes data that is related to operation of the network and data that is not directly related to operation of the network but may impact operation of the network. Multi-modal data may also include data that is not impacted or dependent on operations and functions of the network. Environmental data (e.g., weather, instructions, accidents) are examples of data that are not dependent on operations and functions of the network. Examples of multi-modal data that are not directly related to and/or are unrelated to the operation and function of the network may include data generated by sensors, cameras, LIDAR (Light Detection and Ranging) devices, and the like.

Embodiments of the invention collect or receive multi-modal data and incorporate the multi-modal data into a network graph. This results in an enhanced network graph compared, for example, to a network graph that only includes data related to the operation and functions of the network (e.g., radio frequency (RF) data). Incorporating multi-modal data can improve the performance of models such as graph neural networks (GNNs). For example, the generalizability and scalability of GNNs that rely on enhanced network graphs is improved. These GNNs may be better positioned to understand and generate quality responses for previously unseen scenarios in the network. More specifically, tasks performed by an RIC in a network such as an O-RAN are based on enhanced data stored in the network graph that accounts for or includes multi-modal data.

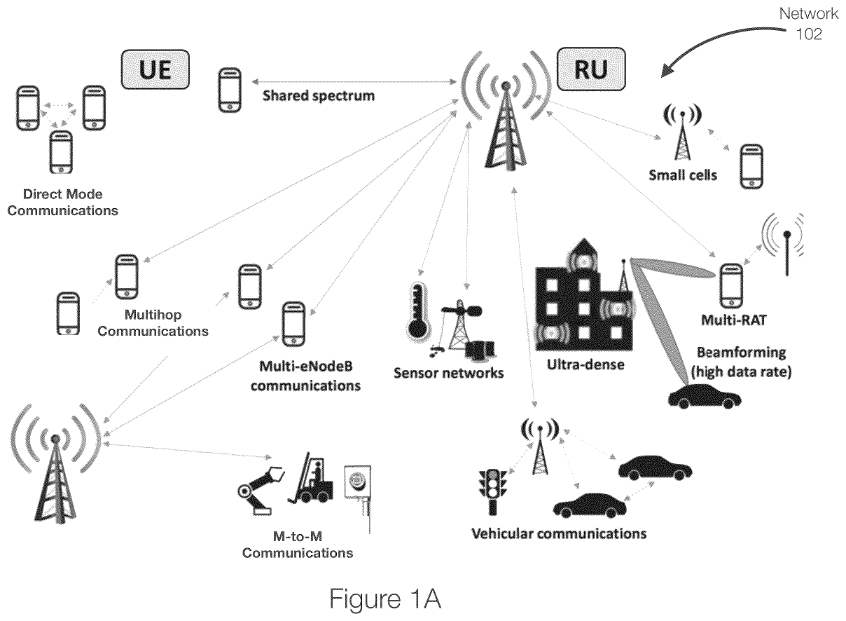

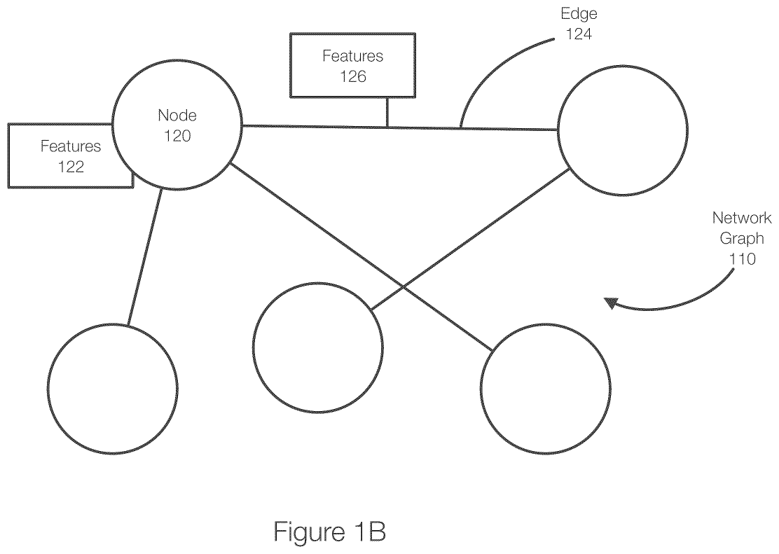

FIG. 1A discloses aspects of a network. FIG. 1 illustrates a network 102, which is an example of or which includes an example of or instances of an O-RAN or RAN. In this example, the network 102 includes towers, small cells, user equipment, multihop communications, multi-enodeB communications, sensor networks, vehicular communications, M-to-M communications, ultra-dense networks multi-RAT, beamforming, and the like. These components may represent or include radio units (RU), distributed units (DU), and/or centralized units (CU).

Embodiments of the invention relate to model-based GNN enhancement in networks, including in network functions, operations, and communications. Network operations and functions are often managed or controlled by an RIC and the RIC may rely on models (e.g., GNNs) and knowledge bases to make decisions or perform tasks. Embodiments of the invention incorporate multi-modal data into a network graph, thereby enhancing the network graph, the output and learning of models in the RIC, including GNNs, decision-making in the network, and/or network management and control operations.

FIG. 1B discloses aspects of a network graph that may represent a network such as a RAN or O-RAN. FIG. 1B illustrates a network graph 110 that represents at least a portion of the network 102 in FIG. 1A. In this example, the network graph 110 includes nodes (may include at least physical and virtual nodes), represented by the node 120, and edges, represented by the edge 124. More specifically, the edge 124 may represent inter-relationships between nodes. Each node and each edge is associated with their own features. The node 120 is associated with features 122 and the edge 124 is associated with features 126.

Generally, each node in the graph 110 may represent a component (e.g., hardware), an application, or the like. In the context of an O-RAN, nodes may represent components in radio units (RUs), distributed units (Dus) and central units (CUs). For example, the node 120 may represent a base station, antenna, a radio, user equipment (UE), a cell, a tower, a network function or application, or the like. If the node 120 represents a base station, the features 122 may include, by way of example only, location (e.g., GPS (Global Positioning System) coordinates), supported frequency bands, maximum number of supported UEs (or traffic capacity), maximum transmission power, antenna configuration, current power usage, operation mode, current serving UEs, and the like or combinations thereof.

The features of any particular node may vary and may depend on what the node represents. For example, if the node 120 represents a cell, the features 122 may include a cell identifier, an area served by the cell, scheduling information, or the like or combinations thereof.

The edges 124 may represent relationships between two or more nodes. The edge 124 may represent, by way of example only, a connection or a relationship between a base station and a cell, a cell and user equipment, a base station and an antenna, a cell and a core network, or the like. The features 126 may depend on the connection or relationship. For example, the features 126 of an edge 124 that represents a connection or relationship between a cell and a UE may include signal strength, allocated resources, handover data, and the like.

The features 122 and 126 may also include characteristics (e.g., stable or constant values such as maximum power, maximum number of connections, software version) and/or measurements or other values that may reflect a current state of the network. For example, the features of a base station may include a total resources feature (fixed or constant) and a resources available feature (variable, depends on usage or load). Thus, resources available feature may vary depending on usage. Similarly, the transmission power of a radio may include maximum power feature and a current transmission power feature.

Stated generally, the network graph 110 is constructed from the network (e.g., the RAN or O-RAN illustrated by or included in the network 102) and include, by way of example, position data, quality of service (QoS) measurements, radio frequency (RF) measurements, and the like. Embodiments of the invention further include environmental semantic information, which may include contextual data, such as environmental data, image data, or the like. More generally, embodiments of the invention relate to enhancing, by way of example, only, network operations, network functions, and/or network configurations in a manner that includes multi-modal data and that accounts for network inter-dependencies.

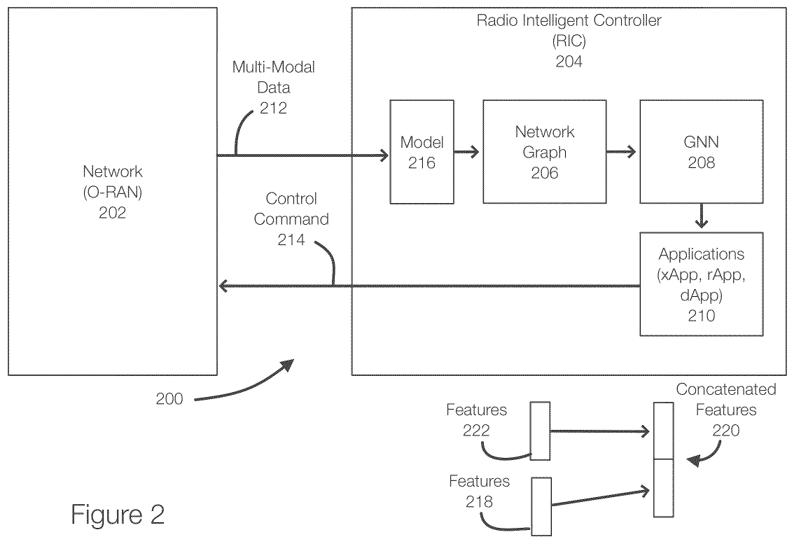

FIG. 2 discloses aspects of a system that includes a network and that is configured to enhance graph neural networks (GNNs) that may be employed in or by a radio intelligent controller (RIC). The system 200 includes an RIC 204 and a network 202. As previously stated, the network 202 may be or may include an O-RAN. Operations, configurations, settings, functions, or the like are typically controlled by the RIC 204.

In an O-RAN, for example, the RIC 204 may perform or manage various operations and tasks with various types of applications 210 that may include rApps (non-real-time-applications), dApps (domain-specific applications) and xApps (near-real-time applications). Generally, rApps may perform various operations or tasks such as managing policy, optimizing performance, and general network orchestration. Examples of rApps may include congestion forecasting, resource/power management, slicing operations, or the like. dApps are often employed in specific domains such as local or private networks, IoT (Internet of Things) operations, and the like. xApps may operate with higher proximity to the network and are configured to tasks or operations that include low-latency operations such as traffic steering, handover operations, or the like.

In this example, the applications 210 may request or receive information from a model such as the GNN 208. The input to the GNN 208 includes a network graph 206. As previously stated, the network graph 206 represents the network 202. The GNN 208 can learn from historical patterns and adapt to changes in the network 202. Thus, the GNN 208 may represent or learn embedded features of the network 202. The GNN 210 has a role in facilitating data-driven execution of network functions and operations.

For example, the GNN 208 may be used for resource management operations or functions. Managing resources such as power, memory, time slots, and the like can be based on the network graph 206 and the embedded features learned by or incorporated into the GNN 208 to generate an output or recommendation to the applications 210. The GNN 208 can efficiently process data to provide intelligent solutions to make network decisions such as a more optimal resource usage/allocation, steering decisions, and the like.

The GNN 208 advantageously provides context awareness, learns from the network graph 206, and is able to adapt to varying or new network topologies, varying or new user behaviors, and the like. As previously stated, embodiments of the invention enhance the network graph 206 with multi-modal data 212. When the GNN 208 is initialized, data from the network graph may be used as initial embeddings. Message passing, attention and aggregation may be performed to improve the embeddings in the GNN 208. This allows the learned embeddings to be used for downstream tasks. The embeddings of the GNN 208, which have been improved using the enhanced network graph 206, can be used for downstream tasks, provide additional context, and are likely to improve network operations and performance.

In this example, the abilities or functions of the GNN 208 are enhanced by the model 216, which is configured to update or enhance the network graph 206 based on multi-modal data. In one example, the multi-modal data 212 may include, by way of example and not limitation, measurements or representations of radio frequency (RF) signals and other key performance indicators (KPIs). KPIs can be categorized into various types including network KPIs (e.g., latency, throughput, connection density), quality of service KPIs (e.g., handover success rate, jitter, network availability), operational KPIs (e.g., resource efficiency/usage, interoperability, fault recovery), AI/ML (artificial intelligence/machine learning) metrics (e.g., accuracy, inference time). These KPIs may include other key performance indicators such as time stamps, velocity (e.g., user equipment speed, direction), signal strengths, latency, throughput, and the like.

The multi-modal data 216 may also include in addition to KPI data, camera data (RGB data, depth data), LiDAR data, RF data, position (e.g., GPS or global positioning system) data, sensor data, or the like or combinations thereof. Data such as camera data, sensor data, LiDAR data, and the like are examples of data that provide additional context and may be environmental or external to the network itself.

For example, a network may be experiencing a performance issue in a base station. Conventional KPIs (e.g., RF data) may suggest that power needs to be increased to resolve a connectivity issue. Multi-modal data, such as camera data, may allow the GNN 208 to discern or determine that the base station is damaged, that the area or position of the base station is experiencing a severe weather condition, or the like.

Embodiments of the invention include a model 216 (e.g., an agentic foundation model (AFM), large model (LM), or large language model (LLM)) configured to generate semantic features from the multi-modal data 212. The semantic features are incorporated to the network graph 206. As a result, the network graph 206 reflects not only features related to the operation and function of the network 202 but also related to the environment and other contexts.

More specifically, the model 216 may receive multi-modal data (e.g., camera images, LiDAR 2D and 3D images, sensor data) and generate semantic features using the contextual information from the physical network 202. Other features, such as RF measurements, may be collected from the network 202 and used as features in the network graph 206.

In one example, the semantic features are concatenated with KPI features to construct the features for each node and each edge of the network graph 206. The features are used to construct and/or enhance the network graph 206. For example, FIG. 2 illustrates features 222 (e.g., KPIs) determined from or associated with KPIs and semantic features 218 determined from or associated with the multi-modal data 212. The features 222 and semantic features 218 are concatenated to generated concatenated features 220.

The enhance network graph 206, which is enhanced with the multi-modal data 212, is passed to the GNN 208 to generate the embedded features of the GNN 208, thereby generating a GNN that is enhanced with multi-modal data. In this example, the applications 210 may use the GNN 208 or more specifically the output of the GNN 208 to perform a target task. The applications 210 may then generate a control command 214, which is sent to and implemented in the network 202. The embedded features allow the applications 210 to make better decisions at least because the multi-modal data provides additional context for the decisions.

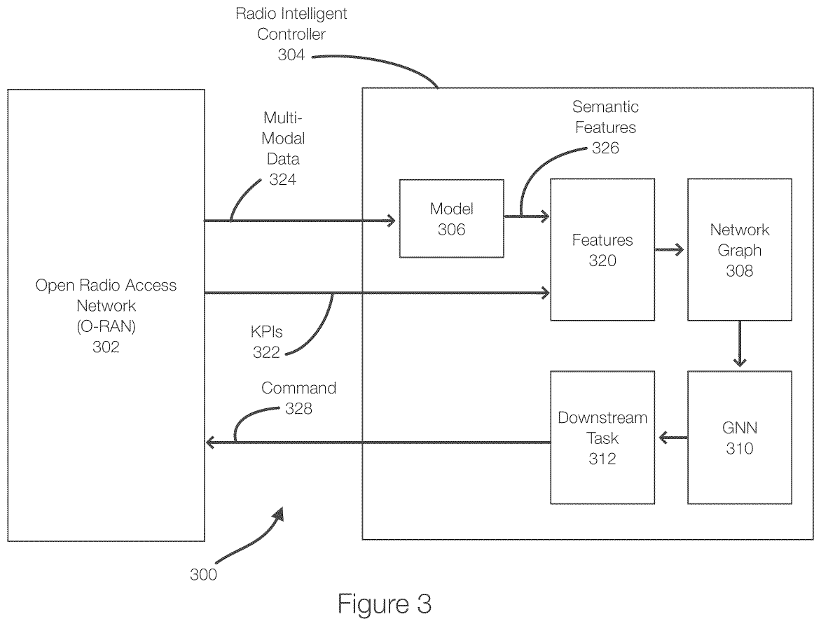

FIG. 3 discloses aspects of a RIC that includes a network graph enhanced with multi-modal data. The system 300, which is an example of the system 200, includes a network 302 and an RIC 304. The network graph 308 is enhanced with multi-modal data 324. In this example, features 320 used to update the network graph 308 include KPIs 322 (a type of multi-modal data) and multi-modal data 324. In this example, the features 320 are generated on a per node and/or per edge basis. This allows nodes and edges in the network graph 308 to be updated separately and independently. The GNN 310 may learn from the updates to update the feature embeddings.

As previously stated, the multi-modal data 324 may include, but is not limited to, camera data (RGB data, depth data), LiDAR data, RF data, position (e.g., GPS or global positioning system) data, KPIs, sensor data, or the like or combinations thereof. The model 306 receives the multi-modal data and generates semantic features 326. The semantic features 326 are combined with features of the KPIs 322 to generate features 320. For example, the sematic features 326 are concatenated with the features associated with or that represent the KPIs 322. The features 320 are added to or incorporated into the network graph 308.

The GNN 310 may iteratively aggregate and transform information from the network graph 308 to learn representations of graph data for various tasks such as the downstream task 312, which may include a command 328 to the network 302. In one example, the downstream task 312 uses the embedded features of the network graph 308 to generate the command 328, which is sent to the network 328. The embedded features capture relationships and properties of data including the multi-modal data 324 and the KPIs 322. In addition, the embedded features account for inter-dependencies that may exist among components or elements in the network 302 or in the system 300.

FIGS. 2 and 3 illustrate that semantic information (e.g., multi-modal data) from the environment may be incorporated into the nodes and edges of the network graph 308. These semantic features may be captured or represented in multi-modal data that goes beyond RF signals or network operation/functions and includes, as previously stated, camera images, sensor data, LiDAR data, and the like.

Adding semantic features and other network features (e.g., RF features) improves the generalizability and scalability of GNNs for networking scenarios, even when those scenarios have not been previously seen or experienced. By including models such as AFMs to incorporate multi-modal data into the network graph, GNNs may require less data and less training overhead compared to conventional methods. AFMs have the ability to collect data, identify current states, detect transitions, log errors, extract knowledge, and the like. Thus, semantic features generated the model 306 may include or reflect relationships, inter-dependencies, states, transitions, and the like. Further, downstream tasks demonstrate improved performance, while reducing energy consumption.

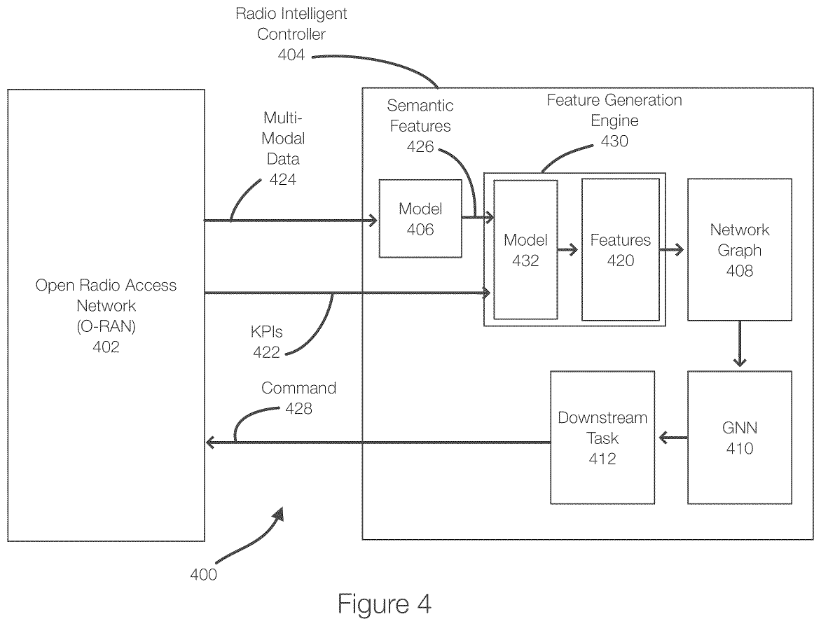

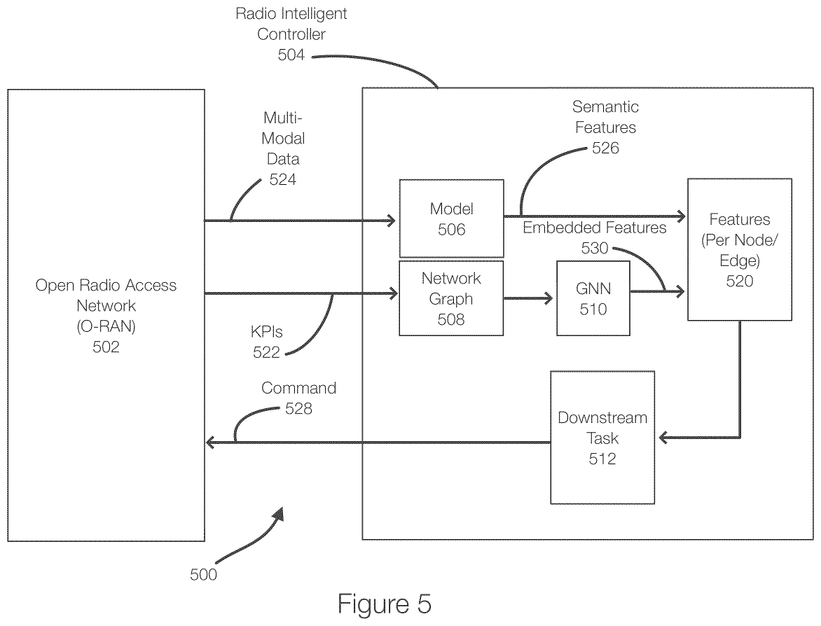

FIGS. 4-5 illustrate additional aspects of systems for using AFMs to enhance GNNs in networks. FIG. 4 illustrates a system 400 that includes a network 402 and an RIC 404. In this example, a model 406 (e.g., an AFM) may receive the multi-modal data and generate semantic features 426.

In this example, the RIC 404 includes a feature generation engine 430, which includes a model 432 configured to generate features 420 from the semantic features 426 and the KPIs 422 (or other features). The model 432 may be a LLM, an AFM, or the like. The model 432 is configured to generate features 420 in a manner that considers non-linear combinations of the semantic features 426 and other features (the KPIs 422). This incorporates inter-dependencies that exist in the network 402 into the features 420. The features 420 are then input to or incorporated into the network graph 408, in one example, on a per node and per edge basis. The embedded features of the GNN 410, learned from the network graph 408, may be used to perform tasks such as the downstream task 412, which may generate a command 428 to the network 402.

FIG. 5 discloses additional aspects of enhancing GNNs in networks. The system 500 includes a network 402 and an RIC 504. In this example, the multi-modal data 524 from the network 520 are input to a model 506 (e.g., an AFM) and semantic features 326 are generated. The KPIs 522 are input to or added to the network graph 508 and the GNN 510 calculates the embedded features of the KPIs 522. The semantic features 526 are combined with the embedded features 530 to generate the features 520, which include features on a per node and/or per edge basis. The features 520 may be used by a downstream task 512 to issue a command 528 to the network 502.

FIGS. 2-5 thus illustrate various manners in which network graphs, embedded features, GNNs, and the like or an RIC are enhanced using multi-modal data. As further illustrated in FIGS. 2-5, the features may be concatenated or otherwise combined at different points, which may depend on the manner in which the combined or concatenated features are generated.

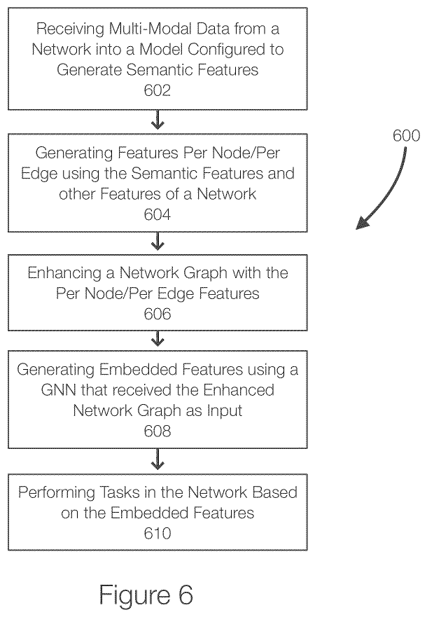

FIG. 6 discloses aspects of enhancing RICs and more specifically to enhancing network graphs and GNNs in network RICs using multi-modal data. In the method 600, multi-modal data may be received 602 from a network into a model such as an AFM. The model may be configured to generate semantic features from the multi-modal data. In one example, embedded features are generated 604 based on the semantic features of the multi-modal data, and/or other features such as KPIs. Thus, current features, which may represent a current state of the network, are generated. In one example, the KPIs are part of the multi-modal data.

A network graph is enhanced 606 with the current features on a per node and per edge basis. A GNN learns or uses the network graph to generate 608 embedded features related to the network. The network graph, which is essentially continually being updated with new features, is used by the GNN to generate embedded features for a current network state. As the data received by the RIC changes, data in the network graph and the embedded features of the GNN adapt to the changing network state.

The method 600 may also include performing 610 tasks in the network. Performing 610 the tasks is based on the feature embeddings in thee GNN in one example. Because the GNN is updated to account for the dynamic state of the network, decisions made in the context of performing tasks relies on most recent or most up to date feature embeddings in one example.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, multi-modal data related operations, network graph operations, GNN operations, task performance operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Further, the AFMs, GNNs, LLMs, and other models may be trained with historical and/or synthetic data.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: receiving multi-modal data from a network into a model, generating semantic features associated with the multi-modal data, combining the semantic features with other features associated at least with key performance indicators of the network to generate combined features, enhancing a network graph of the network with the combined features, generating feature embeddings with a graph neural network (GNN) using the enhanced network graph, and performing tasks in the network based on the feature embeddings of the GNN.

Embodiment 2. The method of embodiment 1, wherein the model generating the semantic features comprises an agentic foundation model trained on historical multi-modal data.

Embodiment 3. The method of embodiment 1 and/or 2, wherein the multi-modal data comprises one or more of camera data, light ranging and detection (LiDAR) data, radio frequency data, position data, sensor data, key performance indicators, network metrics, and/or combinations thereof.

Embodiment 4. The method of embodiment 1, 2, and/or 3, wherein the combined features are generated on a per node and per edge basis.

Embodiment 5. The method of embodiment 1, 2, 3, and/or 4, wherein the multi-modal data is input to a machine learning model configured to generate the combined features.

Embodiment 6. The method of embodiment 1, 2, 3, 4, and/or 5, wherein the multi-modal data is input to the model and other features are input to the network graph, wherein the feature embeddings include the features of the GNN concatenated with the semantic features generated by the model.

Embodiment 7. The method of embodiment 1, 2, 3, 4, 5, and/or 6, further comprising updating the network graph as additional multi-modal data and additional key performance indicators are received from the network.

Embodiment 8. The method of embodiment 1, 2, 3, 4, 5, 6, and/or 7, wherein the GNN considers inter-dependencies that exist in the network.

Embodiment 9. The method of embodiment 1, 2, 3, 4, 5, 6, 7, and/or 8, wherein the network includes a radio access network, an open radio access network, a telecommunications network, a wireless network, or combinations thereof.

Embodiment 10. The method of embodiment 1, 2, 3, 4, 5, 6, 7, 8, and/or 9, wherein the network graph includes data that is constant and/or data that is dynamic such that the feature embeddings reflect a current state of the network and such that decisions made by a radio intelligent controller are based on the current state of the network.

Embodiment 11. The method of embodiment 1, 2, 3, 4, 5, 6, 7, 8, 9, and/or 10, wherein the decisions include downstream tasks performed by applications in or to the network or components of the network.

Embodiment 12. A system, comprising hardware and/or software, operable to perform any of the operations, methods, or processes, or any portion of any of these, disclosed herein.

Embodiment 13. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

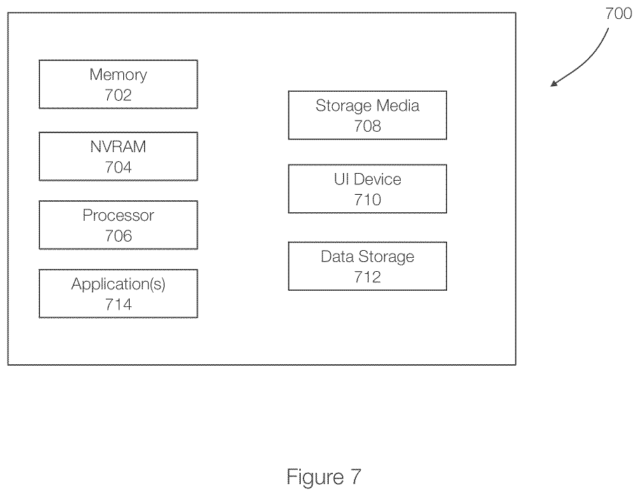

With reference briefly now to FIG. 7, any one or more of the entities disclosed, or implied, by the Figures and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

The device 700 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 700 may also represent a physical or virtual machine or server, an edge-based computing system, a cloud-based computing system, server clusters or other computing systems or environments. The device 700 may also represent multiple machines or devices, whether virtual, containerized, or physical. The device 700 may perform or execute steps or acts of the methods illustrated in the Figures.

The device 700 may represent a cloud-based system, an edge-based, system, an on-premise system, or combinations thereof. The device 700 may be a computing system that is distributed geographically. For example, a network digital twin may include twin components implemented in a plurality of distributed devices 700.

In one example, the RIC and may be integrated with the network, may be implemented using servers, clusters, or the like. The RIC may include distributed components or elements. Data input to the network graphs and models of an RIC may be sourced from multiple locations and multiple models and/or network graphs may be used in parallel.

The described embodiments are to be considered in all respects only as illustrative and not restrictive. All changes which come within the meaning and range of equivalency of the claims are to be embraced within their scope.

What is claimed is:

1. A method comprising:
receiving multi-modal data from a network into a model;
generating semantic features associated with the multi-modal data;
combining the semantic features with other features associated at least with key performance indicators of the network to generate combined features;
enhancing a network graph of the network with the combined features;
generating feature embeddings with a graph neural network (GNN) using the enhanced network graph; and
performing tasks in the network based on the feature embeddings of the GNN.

2. The method of claim 1, wherein the model generating the semantic features comprises an agentic foundation model trained on historical multi-modal data.

3. The method of claim 2, wherein the multi-modal data comprises one or more of camera data, light ranging and detection (LiDAR) data, radio frequency data, position data, sensor data, key performance indicators, network metrics, and/or combinations thereof.

4. The method of claim 1, wherein the combined features are generated on a per node and per edge basis.

5. The method of claim 4, wherein the multi-modal data is input to a machine learning model configured to generate the combined features.

6. The method of claim 4, wherein the multi-modal data is input to the model and other features are input to the network graph, wherein the feature embeddings include the features of the GNN concatenated with the semantic features generated by the model.

7. The method of claim 4, further comprising updating the network graph as additional multi-modal data and additional key performance indicators are received from the network.

8. The method of claim 1, wherein the GNN considers inter-dependencies that exist in the network.

9. The method of claim 1, wherein the network includes a radio access network, an open radio access network, a telecommunications network, a wireless network, or combinations thereof.

10. The method of claim 1, wherein the network graph includes data that is constant and/or data that is dynamic such that the feature embeddings reflect a current state of the network and such that decisions made by a radio intelligent controller are based on the current state of the network.

11. The method of claim 10, wherein the decisions include downstream tasks performed by applications in or to the network or components of the network.

12. A non-transitory storage medium having stored therein instructions that are executable by one or more hardware processors to perform operations comprising:
receiving multi-modal data from a network into a model;
generating semantic features associated with the multi-modal data;
combining the semantic features with other features associated at least with key performance indicators of the network to generate combined features;
enhancing a network graph of the network with the combined features;
generating feature embeddings with a graph neural network (GNN) using the enhanced network graph; and
performing tasks in the network based on the feature embeddings of the GNN.

13. The non-transitory storage medium of claim 12, wherein the model generating the semantic features comprises an agentic foundation model trained on historical multi-modal data, wherein the multi-modal data comprises one or more of camera data, light ranging and detection (LiDAR) data, radio frequency data, position data, sensor data, key performance indicators, network metrics, and/or combinations thereof.

14. The non-transitory storage medium of claim 12, wherein the combined features are generated on a per node and per edge basis.

15. The non-transitory storage medium of claim 14, wherein the multi-modal data is input to a machine learning model configured to generate the combined features.

16. The non-transitory storage medium of claim 14, wherein the multi-modal data is input to the model and other features are input to the network graph, wherein the feature embeddings include the features of the GNN concatenated with the semantic features generated by the model.

17. The non-transitory storage medium of claim 14, further comprising updating the network graph as additional multi-modal data and additional key performance indicators are received from the network.

18. The non-transitory storage medium of claim 12, wherein the GNN considers inter-dependencies that exist in the network, and wherein the network includes a radio access network, an open radio access network, a telecommunications network, a wireless network, or combinations thereof.

19. The non-transitory storage medium of claim 12, wherein the network graph includes data that is constant and/or data that is dynamic such that the feature embeddings reflect a current state of the network and such that decisions made by a radio intelligent controller are based on the current state of the network.

20. The non-transitory storage medium of claim 19, wherein the decisions include downstream tasks performed by applications in or to the network or components of the network.
